(19) United States
(12) Patent Application Publication
(10) Pub. No.: US 2004/0042742 A1
(43) Pub. Date: Mar. 4, 2004

(54) Thermally equalized optical module

(76) Inventors: Scott Bradshaw, Ottawa (CA); Ed Cremer, Ottawa (CA); Neil D. Whaley, Kanata (CA); Sean O'Rourke, Ottawa (CA); Kent Dougall, Kanata (CA)

Correspondence Address: FREEDMAN & ASSOCIATES, 117 CENTREPOINTE DRIVE, SUITE 350, NEPEAN, ONTARIO, K2G 5X3, CA

(21) Appl. No.: 10/228,337

(22) Filed: Aug. 27, 2002

(51) Int. Cl. G02B 6/36

(52) U.S. Cl. 385/94

(57) ABSTRACT

The present invention relates to a thermally insulated optical module. A heat source/sink is thermally coupled with an optical element for sourcing/sinking heat there to/from for temperature regulating the optical element. A thermally insulating packaging forms an enclosure surrounding the optical element. The thermally insulating packaging provides a thermally controlled environment within the enclosure. A thermally conductive structure is disposed within the enclosure and is thermally coupled to the heat source/sink for being temperature regulated thereby. The thermally conductive structure outlines a space surrounding the optical element for providing together with the heat source/sink a second thermally controlled environment therein. The second thermally controlled environment provides a lower temperature gradient across the optical element than absent the thermally conductive structure. Since the optical element is within an environment determined based on dual temperature shielding thereof, adjusting of the temperature at the optical element itself is more easily, accurately, and repeatably performable. For a large range of temperatures outside of the thermal insulating packaging the temperature within the enclosure is adjustable with a known thermal gradient therein. The thermally conductive structure is for sufficiently reducing this thermal gradient within the thermally insulating packaging and, in particular, within the space surrounding the optical element.

### FIELD OF THE INVENTION

This invention generally relates to optical devices for use in optical communication networks and in particular to thermally insulated optical modules.

### BACKGROUND OF THE INVENTION

Optical communication networks have gained widespread acceptance over the past few decades. With the advent of optical fiber, communication signals are transmitted as light propagating along a fiber supporting total internal reflection of the light propagating therein. Many communication systems rely on optical communications because they are less susceptible to noise induced by external sources and are capable of supporting very high speed carrier signals and increased bandwidth. In modern optical networks Wavelength-Division-Multiplexing (WDM) is applied for the simultaneous transmission of many different communication channels at different wavelengths using a single optical waveguide. Typically, the communication channels are provided within a 1530-1565 nanometer (nm) range, and are separated by multiples of 100 Giga Hertz (GHz), i.e. approximately 0.8 nm. Major issues in WDM optical communication networks are the signal quality of each channel and the relative accuracy of the channels, i.e. the wavelength setting for each channel is accurate to within the tolerances set by the International Telecommunications Union (ITU) WDM grid.

A major problem affecting the signal quality and the relative channel accuracy is the sensitivity of the optical elements of the communication network to temperature changes resulting in changes in physical dimensions of and/or physical stresses within the optical elements. For example, in WDM optical communication components expansion, contraction or bending of an optical element due to temperature changes of even less than 1° C. is capable of substantially degrading the optical performance of the network.

In order to reduce signal degradation, temperature sensitive optical elements are assembled in optical modules having the optical element in thermal contact with a temperature regulation system utilizing, for example, a Peltier element and packaged in a sealed container. Such modules are disclosed in the prior art, for example, in U.S. Pat. No. 5,845,031 issued to Aoki in Dec. 1, 1998, U.S. Pat. No. 5,919,383 issued to Beguin et al. in Jul. 6, 1999, U.S. Pat. No. 5,994,679 issued to DeVeau et al. in Nov. 30, 1999, and U.S. Pat. No. 6,114,673 issued to Brewer et al. in Sep. 5, 2000, which are incorporated herein by reference.

However, these prior art modules result in an environment contained in the container having substantial thermal gradients and, furthermore, greatly differing thermal gradients depending on outside conditions. These thermal gradients result in a different temperature at different locations within an optical element disposed in the container. For example, the bottom part of the optical element is attached to a heating element and has a temperature of 60° C. whereas the top of the optical element has a temperature of 59° C. resulting in physical stresses causing substantial signal degradation.

It is an object of the invention to substantially reduce the thermal gradient within and immediately about an optical element disposed in a thermally insulated container.

It is yet further an object of the invention to provide an optical module having a plurality of optical elements disposed therein wherein thermal gradients caused by thermal energy emitting optical elements disposed therein are substantially reduced.

### SUMMARY OF THE INVENTION

In accordance with the present invention there is provided an optical module comprising:

at least an optical element;

a heat source/sink thermally coupled with at least one of the at least an optical element for sourcing/sinking heat there to/from for temperature regulating the at least one optical element;

a thermally insulating packaging forming an enclosure surrounding the at least an optical element, the thermally insulating packaging for providing a first thermally controlled environment within the enclosure; and,

a thermally conductive structure disposed within the enclosure, the thermally conductive structure being thermally coupled to the heat source/sink for being temperature regulated thereby, the thermally conductive structure outlining a space surrounding at least one of the at least one optical element for providing together with the heat source/sink a second thermally controlled environment therein, the second thermally controlled environment for providing a lower temperature gradient across the at least one optical element than absent the thermally conductive structure.

In accordance with the present invention there is further provided an optical module comprising:

a plurality of optical elements wherein, in use, at least one of the plurality of optical elements is emitting thermal energy;

a thermally insulating packaging forming an enclosure surrounding the plurality of optical elements, the thermally insulating packaging for providing a first thermally controlled environment within the enclosure; and,

a thermally conductive structure disposed within the enclosure, the thermally conductive structure being thermally coupled to a heat sink for being temperature regulated thereby, the thermally conductive structure outlining a space surrounding at least one optical element for substantially absorbing the thermal energy emitted.

In accordance with the present invention there is yet further provided an optical sub module comprising:

at least an optical element;

a thermo coupler thermally coupled with the at least an optical element for sourcing/sinking heat there to/from for temperature regulating the at least one optical element, the thermo coupler for being coupled at a predetermined location to a holding structure of a thermally insulating package, the thermally insulating package forming an enclosure surrounding the thermo coupler and the at least an optical element for providing a first thermally controlled environment therein; and,

a thermally conductive structure thermally coupled to the thermo coupler for being temperature regulated thereby, the thermally conductive structure outlining a space surrounding the at least an optical element for providing together with the thermo coupler a second thermally controlled environment within the enclosure.

### BRIEF DESCRIPTION OF THE FIGURES

Exemplary embodiments of the invention will now be described in conjunction with the following drawings, in which:

FIG. 1a is a simplified cross sectional view of an optical module according to the invention;

FIG. 1b is a simplified cross sectional view of another embodiment of an optical module according to the invention;

FIGS. 2a to 2e are simplified perspective views of different embodiments of a thermally conductive structure according to the invention;

FIG. 3 is a simplified cross sectional view of an optical module according to the invention illustrating placement of a plurality of optical elements and thermally conductive structures in a top view;

FIG. 4a is a simplified cross sectional view of an optical module illustrating placement of a thermal energy emitting optical element in combination with other optical elements according to the prior art in a top view;

FIGS. 4b to 4d illustrate different embodiments of placement of a thermal energy emitting optical element and thermally shielding of other optical elements according to the invention in a top view; and,

FIG. 5 is a simplified cross sectional view of yet another embodiment of an optical module according to the invention.

### DETAILED DESCRIPTION OF THE INVENTION

The present invention provides a thermally conductive structure in thermal contact with a base and surrounding an optical element disposed within a thermally insulated packaging. Due to the dual temperature shielding a temperature gradient within a space surrounding the optical element and, therefore, across the optical element is substantially lower than absent the thermally conductive structure. Since the optical element is within an environment determined based on dual temperature shielding thereof, adjusting of the temperature at the optical element itself is more easily, accurately, and repeatably performable. For a large range of temperatures outside of the thermal insulating packaging the temperature within the enclosure is adjustable with a known thermal gradient therein. The thermally conductive structure is for sufficiently reducing this thermal gradient within a portion of the thermally insulating packaging and, in particular, within the space surrounding the optical element.

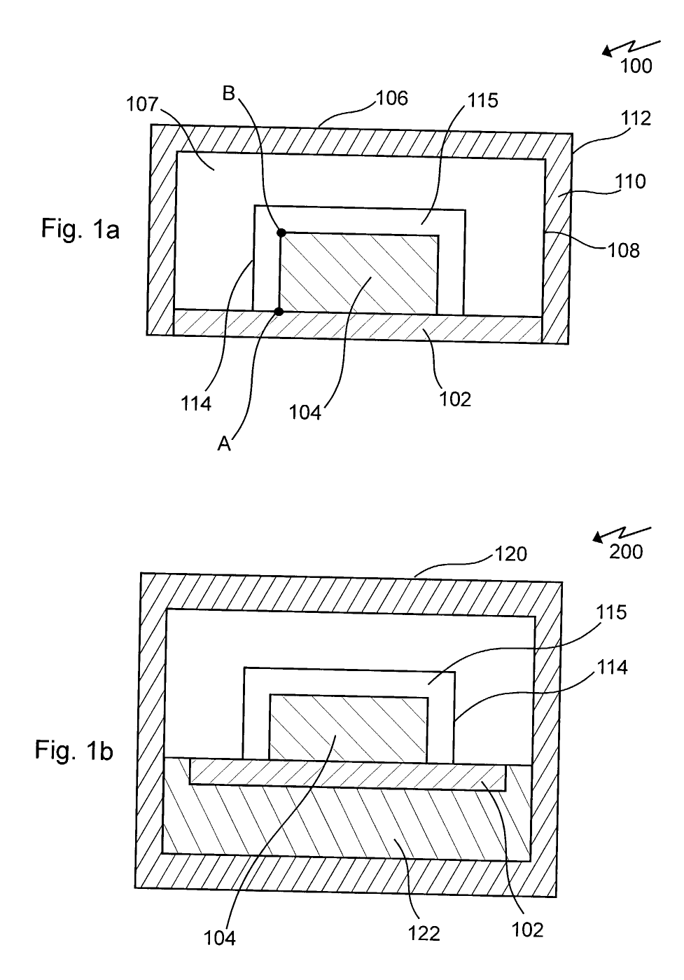

Optical modules are designed to provide a controlled environment for the protection of sensitive optical elements. A major aspect in the design of optical modules is the adjustment of the operational temperature of the optical elements. Referring to FIG. 1a, an optical module 100 according to the invention is shown. The optical module 100 comprises an optical element 104. A heat source/sink 102 is thermally coupled with the optical element 104 for sourcing/sinking heat to/from the optical element 104. The heat source/sink 102 provides temperature regulation of the optical element 104 in order to keep its operating temperature within predetermined limits. Depending on the normal operating temperature of the optical element 104 and an ambient temperature of an environment where the optical module is placed the heat source/sink 102 is a heat source such as, for example, a resistive heating element or a Peltier thermoelectric device. Alternatively, the heat source/sink is a heat sink and, for example, the Peltier thermoelectric device is operated as such. Preferably, the optical element 104 is coupled to the heat source/sink 102 using a thermally conductive material in order to provide good thermal coupling. The optical element 104 is contained within a thermally conductive packaging 106. The thermally conductive packaging 106 forms an enclosure 107 surrounding the optical element 104 and provides an approximately isothermal environment within the enclosure 107. Packaging is commercially available and generally comprises an outside wall and air within the package. Alternatively, a package includes an inside wall 108, an outside wall 112, and an intermediate layer 110 disposed therebetween. In one embodiment, shown in FIG. 1a, the heat source/sink 102 is abutted to the thermally conductive packaging 106 forming together with the thermally conductive packaging 106. Optionally, the inside wall 108 is also made of a thermally conductive material and thermally coupled to the heat source/sink 102 making the inside wall 108 a portion of the heat source/sink. In another embodiment 200 the heat source/sink 102 is disposed within a thermally conductive packaging 120 as shown in FIG. 1b. Optionally, the heat source/sink 102 is thermally insulated from the packaging 120 using, for example, a thermally insulating medium 122.

The optical modules 100, 200 further comprise a thermally conductive structure 114. The thermally conductive structure 114 is thermally coupled to the heat source sink 102 for being temperature regulated thereby. The thermally conductive structure 114 outlines a space 115 surrounding the optical element 104 and provides together with the heat source/sink 102 a second thermally controlled environment therein. The second thermally controlled environment provides a lower temperature gradient across the optical element 104 than absent the thermally conductive structure 114.

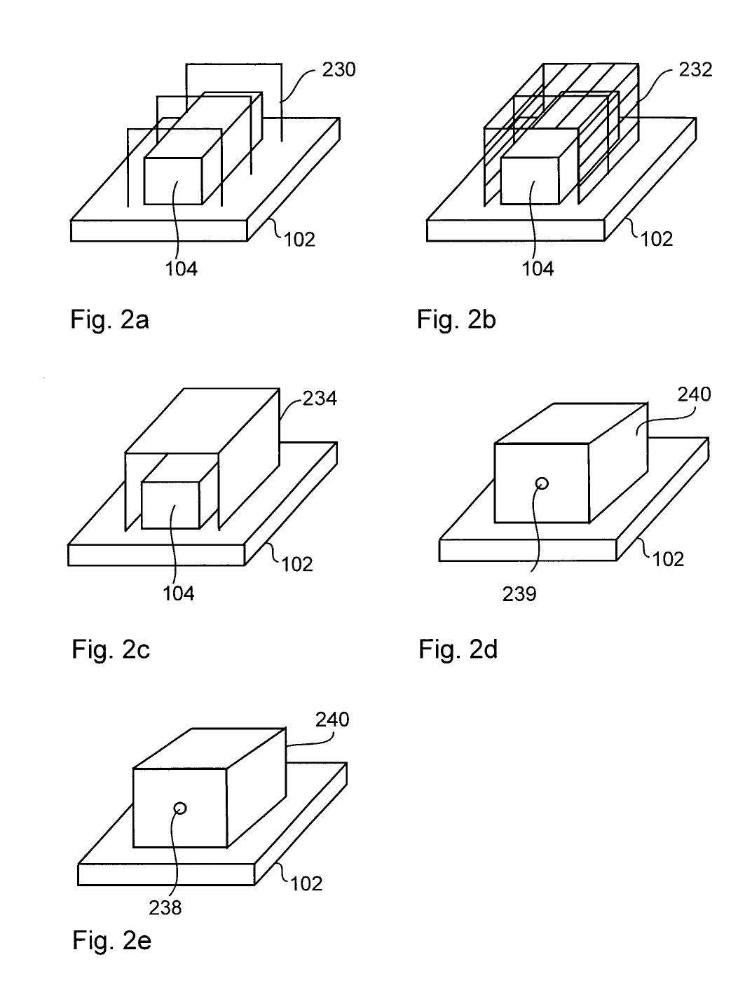

Referring to FIGS. 2a to 2e various embodiments of the thermally conductive structure 114 according to the invention are shown. Advancing from FIG. 2a to FIG. 2e temperature control within space 115 is improved. FIG. 2a shows the simplest embodiment of the secondary thermally conductive structure 114 being made of a plurality of U-bent wires or rods 230 surrounding the optical element 104. In the embodiment shown in FIG. 2b the wires are replaced by a U-shaped cover made of a wire mesh 232. Replacing the wire mesh with a sheet material 234, as shown in FIG. 2c, substantially increases the surface area for heat conduction thus improving temperature control within the space 115. Referring to FIG. 2d, the container 240 replaces the cover incorporated in the FIGS. 2a to 2c. The container 240, together with the hear source/sink 102, provides a nearly complete enclosure for the optical element 104, however the container 240 does not provide a sealed environment. As shown, the container 240 includes an optically transparent region 239. The optically transparent region permits optical communication between the optical component 104 (not shown) and an optical waveguide outside the container 240. In the embodiment shown in FIG. 2e, the cover is again replaced with a container 240. The container 240 includes an opening 238 for allowing propagation of a light beam therethrough. As is evident, there are numerous methods for thermally coupling the thermally conductive structure 114 to the heat source/sink 102 such as inserting a portion of the thermally conductive structure 114 into a slot or groove disposed in the heat source/sink 102 at a predetermined location, or affixing the thermally conductive structure 114 to the heat source/sink 102 using an adhesive.

Preferably, the thermally conductive structure 114 is made of a material having high thermal conductivity, for example, metals such as Al or CuMo alloy. The thickness of the metal or the diameter of the wires used is dimensioned large enough to provide sufficient thermal conductivity within the thermally conductive structure. Further preferably, the thermally conductive structure 114 is designed to have sufficient thermal conductivity ensuring the structure to be approximately isothermal during normal operation of the optical element 104.

The thermally conductive structure 114 provides together with the heat source/sink 102 in the space 115 surrounding the optical element 104 a second thermally controlled environment. Due to the dual temperature shielding, a temperature gradient within the space 115 and, therefore, across the optical element 104, for example, between points A and B in FIG. 1a, is substantially lower than absent the thermally conductive structure 114. Since the optical element 104 is within an environment determined based on dual temperature shielding thereof, adjusting of the temperature at the optical element 104 itself is more easily, accurately, and repeatably performable. For a large range of temperatures outside of the thermal insulating packaging 106 the temperature within the enclosure 107 is adjustable with a known thermal gradient therein. The thermally conductive structure 114 is for sufficiently reducing this thermal gradient within the enclosure 107 and, in particular, within the space 115. Thus, whereas prior art devices result in greatly differing thermal gradients depending on outside conditions, the present invention improves an operating range for an optical module without requiring that the optical element 104 supports extremely varied thermal gradients across. Therefore, the optical module according to the invention allows use of highly thermally sensitive optical elements for a large range of outside temperatures.

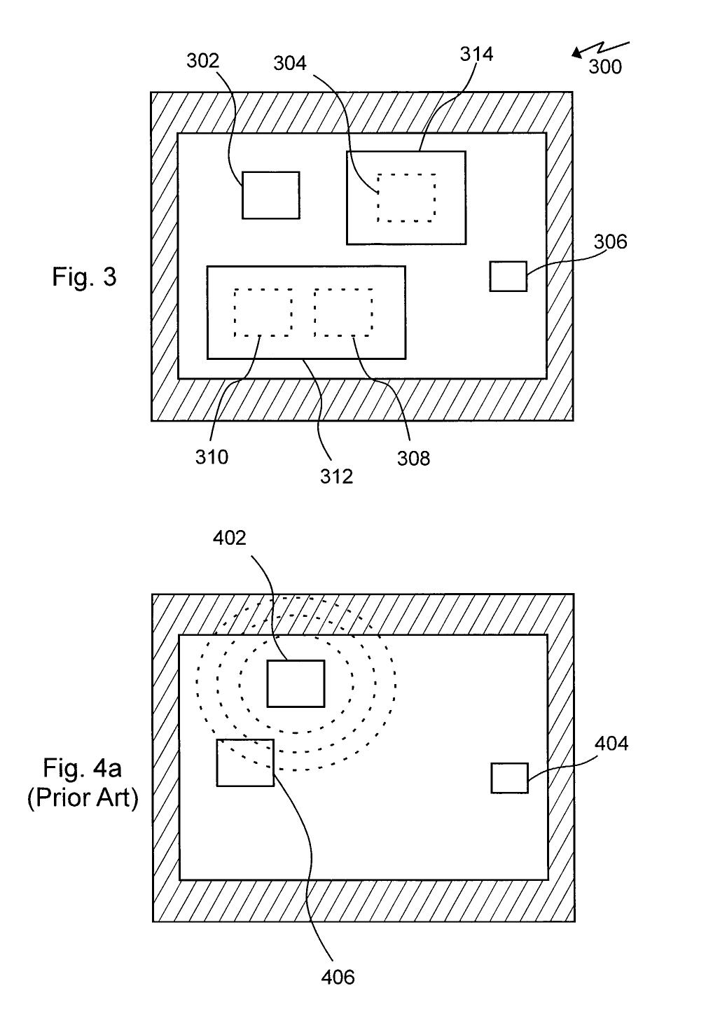

Referring to FIG. 3, an optical module 300 according to the invention is shown. The optical module 300 includes a plurality of optical elements, for example, elements 302, 304, 306, 308, and 310 as shown in FIG. 3. Using prior art thermal insulation techniques requires a thermally insulating packaging meeting the most stringent requirements for protecting the most thermally sensitive optical element of the plurality of optical elements often resulting in a high cost package. As shown in FIG. 3, the present invention provides an apparatus for individual temperature adjustment of each optical element depending on their thermal sensitivity. For example, the optical elements 302 and 306 are less thermally sensitive and, therefore, need not have a thermal conductive structure disposed thereabout. The optical elements 308 and 310 are more thermally sensitive and are provided with, for example, a thermally protective structure 312 such as shown, for example in FIG. 2c. The optical element 304, for example, is highly thermally sensitive and is provided with a sealed thermally conductive structure 314. As shown in FIG. 3, it is possible to nest a plurality of optical elements having an approximately same thermal sensitivity in groups under one thermally conductive structure so long as none of the elements generates substantial amounts of heat. The optical module 300 is highly advantageous by allowing optional temperature isolation at each optical element individually in accordance with its thermal sensitivity due to the plural temperature shielding. Therefore, adjustment of the operational temperature of each individual optical element is more easily, accurately, and repeatably performable.

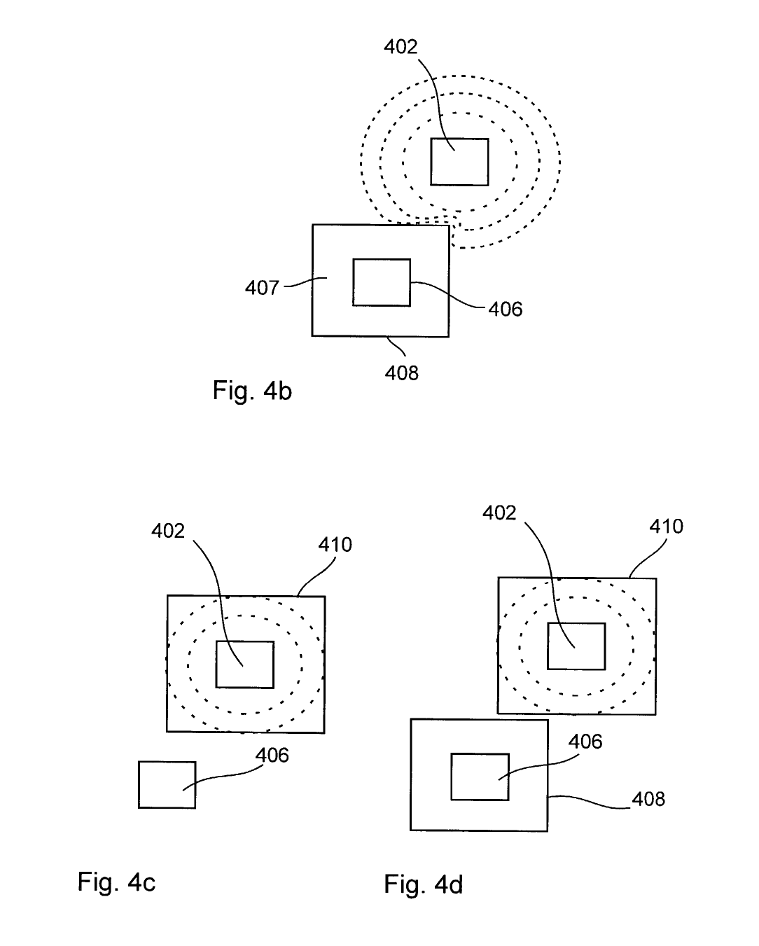

Another advantage of the present invention is the capability of combining thermal energy emitting optical components such as a laser diode with thermal sensitive optical elements in one optical module. Referring to FIG. 4a a combination of a thermal energy emitting optical component with optical elements 404, and 406 in one module according to the prior art is shown. As is evident, the optical element 406 in proximity of the thermal energy emitting optical element 402 is affected by the presence of the heat source as indicated by the isothermals—dashed lines—surrounding the thermal energy emitting optical element 402. As shown in FIG. 4a the optical element 406 is located in an area having a substantial thermal gradient—temperature change normal to the isothermals—resulting in a thermal gradient across the optical element 406. Known solutions to this problem include using a fan to provide forced convection inside the optical module in order to equalize the temperature field, thus reducing the thermal gradient and thermal isolation of different elements within different packages disposed in a spaced relation. These options, in general, results in large optical modules in order to provide enough space for the placement of thermally sensitive optical elements and severely restricts the design of optical circuits placed in the optical module. The size limitations of optical modules, reliability aspects and cost constraints often render these solutions prohibitive.

This problem is easily solved by the present invention. For example, providing the thermally sensitive optical element 406 with a thermally conductive structure 408 substantially reduces the thermal gradient induced by the thermal energy emitting optical element 402 within a space 407 surrounding the optical element 406, as shown in FIG. 4b. For a highly thermal sensitive optical element a sealed thermally conductive structure substantially blocking the thermal energy emitted from the optical element 402 is preferred. In another embodiment shown in FIG. 4c the thermal energy emitting optical element 402 is provided with a thermally conductive structure 410 for substantially absorbing the emitted thermal energy and thus for protecting the optical element 406. Optionally, the embodiments shown in FIGS. 4b and 4c are combined to provide maximum thermal protection of the optical element 406 as shown in FIG. 4d.

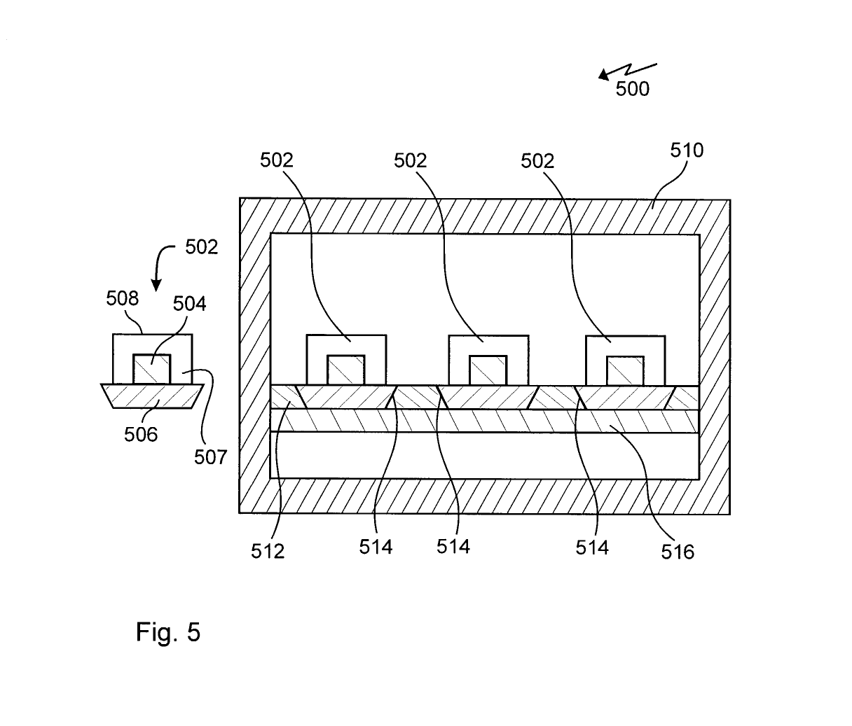

Referring to FIG. 5, yet another embodiment 500 of an optical module according to the invention is shown. Here, a thermal insulating packaging 510 is provided with a holding structure having openings or insertion slots 514 at predetermined locations for insertion of optical sub modules 502. The optical sub modules 502 comprise at least an optical element 504. A thermo coupler 506 is thermally coupled with the at least an optical element 504 for sourcing/sinking heat there to/from for temperature regulating the at least an optical element 504. A thermally conductive structure 508 is thermally coupled to the thermo coupler 506 for being temperature regulated thereby. The thermally conductive structure 508 provides a space 507 surrounding the at least an optical element 504 for providing together with the thermo coupler a thermally controlled environment surrounding the at least an optical element 504. The thermo coupler 506 is a thermally conductive coupler for conducting heat to/from an active heat source/sink 516 such as a Peltier thermoelectric device disposed in the thermally insulating packaging 510. Alternatively, the thermo coupler 506 is an active heat source/sink having electrical contacts to be mated with their counterparts disposed in the thermally insulating packaging 510, not shown. The holding structure 512 is made of a thermally conductive material or, alternatively, of a thermally insulating material depending on design considerations. For example, having a holding structure 512 made of a thermally insulating material allows insertion of optical sub modules having heat sources/sinks operated at different temperatures, thus increasing design flexibility. The optical module 500 according to the invention allows easy assembly of the same using prefabricated sub modules. This is highly advantageous by enabling, for example, a technician to assemble the optical module 500 on site according to design considerations of an optical network. In a preferred embodiment the optical sub modules 502 are sealed.

Of course, though in the preferred embodiments the thermally conductive structure is disposed on a base having active heating/cooling thereof, this is not necessary. In an embodiment, the thermally conductive structure is disposed on a thermally conductive base to provide increased heat conduction about the optical element in order to maintain the optical element in an environment with little or no temperature gradients therein. Thus, active temperature control is not required for the invention. Of course, even a thermally conductive base material acts as a source/sink when used in accordance with the invention though it is distinguishable from an active heat source/sink.

The term “highly thermally conductive” as used herein and in the claims that follow refers to a material that conducts heat well such as Al or Cu. Typically, materials such as air, fiberglass, glass and so forth are not highly conductive and it is anticipated that some forms of ceramic material may in fact be highly thermally conductive and others may be more insulating than thermally conductive. The term insulating material refers to a material that insulates between two thermal regions even though that material is nominally thermally conductive in nature.

Numerous other embodiments of the invention will be apparent to persons skilled in the art without departing from the spirit and scope of the invention as defined in the appended claims.

What is claimed is:

1. An optical module comprising:
an optical element;
a heat source/sink thermally coupled with the optical element for sourcing/sinking heat there to/from;
a thermally insulating packaging forming an enclosure surrounding the optical element, the thermally insulating packaging for providing a first thermally controlled environment within the enclosure; and,
a highly thermally conductive structure disposed within the enclosure, the thermally conductive structure being thermally coupled to the heat source/sink, the thermally conductive structure outlining a space surrounding the optical element for providing together with the heat source/sink a second thermally controlled environment therein, the second thermally controlled environment for providing a lower temperature gradient across the optical element than absent the thermally conductive structure.

2. An optical module according to claim 1, wherein the heat source/sink is an active heat source/sink for temperature regulating the optical element and disposed in abutted relation to the thermally insulating packaging.

3. An optical module according to claim 2, wherein a portion of the thermally insulating packaging is a portion of the active heat source/sink.

4. An optical module according to claim 1, wherein the heat source/sink is thermally insulated from the thermally insulating packaging for reducing heat transfer between the heat source/sink and the thermally insulating packaging.

5. An optical module according to claim 1, wherein the heat source/sink is a Peltier thermoelectric device.

6. An optical module according to claim 1, wherein the thermally conductive structure is designed to be approximately isothermal during normal operation of the optical element.

7. An optical module according to claim 6, wherein the thermally conductive structure comprises a plurality of U-bent metal wires.

8. An optical module according to claim 7, wherein the plurality of U-bent metal wires form a portion of a U-shaped wire mesh.

9. An optical module according to claim 6, wherein the thermally conductive structure comprises a U-shaped cover.

10. An optical module according to claim 9, wherein the U-shaped cover is made of a conductive metal.

11. An optical module according to claim 9, wherein the thermally conductive structure comprises a second U-shaped cover disposed perpendicular to the first U-shaped cover.

12. An optical module according to claim 1, comprising a second optical element outside the second thermally controlled environment, wherein the optical element surrounded by the second thermally controlled environment has a higher thermal sensitivity than the second optical element.

13. An optical module according to claim 12, comprising a second different thermally conductive structure disposed within the enclosure, the thermally conductive structure being thermally coupled to the heat source/sink, the thermally conductive structure outlining a space surrounding at least one other of the at least one optical element for providing together with the heat source/sink a third thermally controlled environment therein, the third thermally controlled environment for providing a second other lower temperature gradient across the at least one other optical element than absent the second thermally conductive structure.

14. An optical module according to claim 13, wherein the other of the at least one optical component has a different thermal sensitivity than the at least one optical element.

15. An optical module comprising:
a first optical element;
a second optical element;
a thermally insulating packaging forming an enclosure surrounding the first and the second optical element, the thermally insulating packaging for providing a first thermally controlled environment within the enclosure; and,
a highly thermally conductive structure disposed within the enclosure, the thermally conductive structure being thermally coupled to a heat source/sink and outlining a space surrounding the first optical element.

16. An optical module according to claim 15, wherein the heat source/sink is an active heat source/sink.

17. An optical module according to claim 15, wherein the second optical element is a thermal energy emitting optical element and wherein the thermally conductive structure is for substantially absorbing thermal energy emitted thereby.

18. An optical module according to claim 15, wherein the first optical element is a thermal energy emitting optical element and wherein the thermally conductive structure is for substantially absorbing thermal energy emitted thereby.

19. An optical module according to claim 18, wherein the second optical element is an optical element other than a thermal energy emitting optical element.

20. An optical module according to claim 19, wherein the second optical element is located in proximity to the first optical element.

21. An optical module according to claim 15, comprising a second thermally conductive structure disposed within the enclosure, the second thermally conductive structure being thermally coupled to the heat source/sink and outlining a second space surrounding the second optical element for providing together with the heat source/sink a second thermally shielded environment therein.

22. An optical component for being mounted within an optical module comprising:
an optical element;
a thermally conductive surface coupled with the optical element for sourcing/sinking heat there to/from for temperature regulating the optical element; and,
a highly thermally conductive structure thermally coupled to the thermally conductive surface and outlining a space surrounding the optical element for providing together with the thermally conductive surface an open structure allowing gas flow about the optical element and allowing substantial gas flow into and out of the open structure.

23. An optical sub module according to claim 22, wherein the thermally conductive surface is an active heat source/sink.

24. An optical sub module according to claim 23, wherein the active heat source/sink is a Peltier thermoelectric device.

25. An optical sub module according to claim 22, wherein the thermally conductive surface is a thermally conductive coupler for conducting heat to/from an active heat source/sink.
